(19) United States
(12) Patent Application Publication
(10) Pub. No.: US 2023/0054910 A1
(43) Pub. Date: Feb. 23, 2023

(54) VISUALLY IMPAIRED MULTI-FUNCTION HIKING CANE

(71) Applicant: Awarewolf Gear, LLC, Timonium, MD (US)

(72) Inventor: David Epstein, Timonium, MD (US)

(21) Appl. No.: 17/406,348

(22) Filed: Aug. 19, 2021

(51) Int. Cl. A61H 3/06; A45B 9/00

(52) U.S. Cl. CPC A61H 3/068; A45B 9/00; A45B 2009/002; A45B 2009/007

(57) ABSTRACT

A multi-function cane for the visually impaired can have an adjustable elongate shaft, a distal tip with a free end for contacting the walking surface, and a compression brake disposed between the shaft and the distal tip. The distal tip can have a distal portion rotatable about the axis of the cane shaft. The compression brake can allow the distal tip of the multi-function cane to rotate so the cane operates as a mobility cane when the brake is disengaged. The application of a compressive longitudinal force can engage the brake to prevent rotation of the distal tip so the cane can be load-bearing to operate as a support cane.

### FIELD OF INVENTION

The present invention relates to an apparatus to aid the mobility of the visually impaired. More particularly, this invention relates to an apparatus useful to for combining the benefits of a mobility cane with those of a support cane to assist the visually impaired in traversing uneven and rough terrain.

### BACKGROUND

One of the most severe handicaps a person with impaired vision often encounters is a lack of mobility. A cane may be used to help alleviate this issue and provide the visually impaired person more substantial mobility. Visually impaired mobility canes (often called “white” canes or “long” canes) typically have a tip for contacting the ground and an elastic shock cord that runs through the hollow body of the cane. When in use, the mobility cane can offer echo-ranging cues and force-impact data. Combined with other senses, this information allows a user to form a picture of the nature and condition of the immediate environment in their path, while protecting the traveler from grade changes, drop-offs, and lower body collisions.

For these purposes, the body of a visually impaired mobility cane is commonly made up of a plurality of segments with thin wall thicknesses that inter-fit to provide a long shaft when in use and may be separated to provide for a compact bundle when not in use. Additionally, the tip is often a spherical or cylindrical “rolling” designed to move and rotate when in contact with the ground. For these reasons, the visually impaired mobility cane is not designed or intended bear a substantial compressive load, and a visually impaired user is often instructed not to place any significant weight onto the visually impaired mobility cane.

The non-load-bearing feature of a visually impaired mobility cane is opposite to a more standard support cane, typically used to bear some of the weight of a user. This distinction is born out of the particular use of the visually impaired mobility cane. A tip of the visually impaired mobility cane is typically held away from the user and the tip used to “search” or “scan” the ground in front for any obstacles or drop-offs. Using a visually impaired mobility cane to bear weight is counter to conventional wisdom, as it is typically not robust enough and visually impaired individuals who have been taught the proper techniques for using the mobility cane are instructed to avoid using it for support. As a result, the visually impaired can often find it difficult to navigate terrain with inconsistent and/or rapidly changing ground-surface asperities and textures. Additionally, movable tips and the inability to handle compressive loads for support mean a mobility cane cannot be counted on for stable behavior in situations of momentary imbalance, such as tripping, rising from a seat, or accelerations in a moving vehicle.

Visually impaired users in these situations would often prefer a support cane. For the example of hiking or traversing rough or uneven terrain, a walking stick or trekking pole may be preferred as an article that can help bear the user's weight as they traverse the trail or ground. A support cane can broaden the user's base of support and improving balance through load-bearing capability while freeing the rest of the body to allow for multi-point support (i.e., three point contact/control, etc.). Under the current circumstances a visually impaired person would require two implements, their visually impaired mobility cane in one hand and a walking stick in the other for stability. This occupies both hands which prevents a visually impaired user from having a free hand for balance, stability, or other purposes.

Thus, what is needed is a multi-purpose or multi-function mobility cane for the visually impaired that can double as a weight-bearing support cane over uneven or rough terrain.

### SUMMARY

It is an object of the present designs to provide devices and methods to meet the above- stated needs. The designs can be a cane having a grip, shaft, and tip which have features to support both the mobility functions of a mobility cane and a means to seamlessly offer load-bearing support functions when required.

In some examples, a multi-function cane can have an elongate shaft, a compression brake disposed at the distal end of the elongate shaft, and a distal tip. The elongate shaft can have a proximal end with a grip for the user, a distal end, and a longitudinal axis. The cane can be designed so as to be capable of functioning as both a mobility cane and/or as a support cane for hiking and other load-bearing activities where additional balance and support are required.

The shaft can have a number of telescoping segments capable of moving in relation to each other along the longitudinal axis to extend or shorten the length of the shaft. The telescoping motion can occur at joints between the telescoping segments such that the cane is adjustable between a collapsed configuration for storage and an expanded configuration adjustable to the shaft length suited for the user and the application. In many examples, the joints can have locking features allowing them to fix the relative position of the segments, so the cane is fixed at a desired length between a fully collapsed length and a fully extended length. In some examples, the joints can have twist lock features. In other examples, the joints can have tab lock or cam lock features. Other locking features can also be envisioned to serve the function of fixing the shaft length.

In some designs, the compression brake can have a housing fixedly attached at the distal end of the elongate shaft and function so that when the brake is in a disengaged state, the user can use the cane in a mobility mode for identifying objects around the user. The disengaged state allows relative motion, such as rolling, between the distal tip and the elongate shaft. In other situations where fixed positioning or stability support is needed, the user can alternately engage the compression brake which prevents rotation of the distal tip.

In some examples, the distal tip can be positioned distal of the compression brake such that it is rotatable around the longitudinal axis relative to the brake and elongate shaft. For ease of rotation, the tip can have a shape with a free end which reduces rolling friction when it contacts the ground for when the cane is held and used as a mobility cane. The shape can be radially symmetric about the axis so the cane is self-balancing in the user's hand. In one instance, the tip is a hemispheroidal or spherical ball. In another example, the tip can have a substantially cylindrical profile with a filleted contact edge. In still another example, the tip can have a disc shape. Tips with elliptical cylindrical cross sections or other profiles can also be envisioned. In some or all of these examples, the distal tip can be designed to be readily removed from the elongate shaft of the cane for repair, replacement, exchange, or other purposes.

In some cases, the distal tip can have a cylindrical proximal portion sized to fit and translate within a recess in the housing of the compression brake. The compression brake can also have a spring and at least one high friction surface within the recess. The cylindrical proximal portion of the distal tip can be free to rotate relative to the spring and the housing of the compression brake.

When a vision impaired user wishes to use the cane in a support mode as a support cane, he or she can react the distal tip against the ground to apply a compressive load on the cane so the distal tip moves proximally to compress the spring. This results in the proximal face of the cylindrical proximal portion of the distal tip moving into contact with the high-friction surface of the brake housing to engage the compression brake. To aid in reacting to these loads, the distal tip can have a distal face with at least a portion having a non-slip design to improve traction when held and used as a support cane. In some examples, a rubberized construction or coating can be used for a portion of the distal face. In other examples, a portion of the distal face can have tread plate or another embossed pattern.

Similarly, a mobility mode can be envisaged wherein no axial force is applied to the cane by the user, or when an applied force is released. The stored energy in the compressed spring can then push the proximal face of the cylindrical proximal portion distally away from the high-friction surface to disengage the compression brake. When disengaged, the distal tip is then free to resume rotation relative to the shaft so the user can resume scanning surroundings.

In other examples, a multi-function cane for a vision impaired user can have an elongate shaft with a plurality of telescoping segments extending between a proximal end and a distal end. The proximal end can have a grip for manipulation by the user. The grip can be of a variety of constructions and lengths. In some examples, the grip can have a length in a range from approximately six inches to approximately 24 inches. In another example, the grip can have a length of approximately 18 inches.

The telescoping segments of the shaft can have a tubular construction so as to define a longitudinal axis for the shaft. The joints can allow axial movement of the telescoping segments along the axis to adjust the length of the cane shaft. In many examples, the joints can also have locking features capable of fixing the relative position of adjacent telescoping segments once the cane is at the desired length.

In some cases, the cane can have a removable distal tip disposed at the distal end of the elongate shaft. The distal tip can be a substantially spherical ball rotatable about the longitudinal axis of the shaft. When used as a mobility cane, a free surface at the distal end of the spherical ball can be tracked in an arc across the ground by the vision impaired user to gather information and avoid potential obstacles.

A compression brake can be disposed between the distal end of the elongate shaft and the distal tip. The compression brake can have an engaged configuration limiting or preventing the relative rotation between the distal tip and the elongate shaft, and an open configuration allowing this relative rotation.

In some examples, a method for the use of a multi-function cane capable of being used both for mobility and support can be disclosed. The method can include using a brake to couple an adjustable-length tubular shaft to a distal tip. The distal tip can be capable of rotation about the axis of the shaft and the rotation can be metered by the brake.

A step of the method can involve a vision impaired user utilizing the cane as a mobility cane. In this situation, the telescoping tubular length of the shaft can be adjusted so the cane can be held with the distal tip resting on the ground in the user's walking path, so the cane forms an acute angle with the ground. The length can be sufficient to provide the user with ample reaction time without inhibiting physical freedom, and the angle can be shallow enough to advance the distal tip of the cane without inducing or requiring vertical reaction loads. In some examples, the angle formed between the cane and the ground can be equal to or less than 60 degrees. In other examples, the angle can be 50 degrees or less.

The grip of the cane can be long enough such that the user can position their hand at an ergonomically comfortable first position for scanning as a mobility cane. Using the mobility cane can involve repeatedly rolling the rotating distal tip in an arc in front of the user to inform about the condition of the surface underfoot and forewarn of drop-offs or collisions.

When a more transient surface with asperities is detected by the user (either expected or unexpected), the method can involve the user adjusting the grip to a second position for support to increase the ground angle of the cane, transitioning the role of the implement to provide support for at least a portion of the user's weight. The method can further involve the user reacting compressive loads using the distal tip of the cane to engage a compression brake which prevents any rolling rotation of the distal tip with respect to the cane shaft. This allows the cane to be more stable and bear compressive loading for support and/or locomotion assistance.

A further step in the method can involve the user readjusting their grip to the first position to resume use of the cane for mobility. Transitioning between any steps can involve, if desired, an adjustment of the length of the cane through use of the telescoping segments of the shaft.

Other aspects of the present disclosure will become apparent upon reviewing the following detailed description in conjunction with the accompanying figures. Additional features can be included as would be appreciated and understood by a person of ordinary skill in the art.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation. It is expected that those of skill in the art can conceive of and combine elements from multiple figures to better suit the needs of the user. For clarity, not every component is labeled in every figure, nor is every component of the device or method illustrated where not necessary.

FIG. 1 is a view of a multi-function cane according to aspects of the present invention;

FIG. 2 illustrates the multi-function cane of FIG. 1 in a collapsed state according to aspects of the present invention;

FIG. 3 shows twist locks used to fix the length of the shaft of the multi-function cane according to aspects of the present invention;

FIG. 4 depicts tab locks used to fix the length of the shaft of the multi-function cane according to aspects of the present invention;

FIG. 5 illustrates a distal tip for a multi-function cane according to aspects of the present invention;

FIGS. 6A-6B are another example a distal tip for a multi-function cane according to aspects of the present invention;

FIG. 7 is a cross section view of the brake from FIG. 6A according to aspects of the present invention;

FIG. 8 is a cross section view of the brake from FIG. 6B according to aspects of the present invention;

FIG. 9 is an example of a pattern on the free end of the distal tip according to aspects of the present invention;

FIG. 10 is a view of the cane grip with weights added for balancing according to aspects of the present invention;

FIG. 11 depicts a user using the multi-function cane as a mobility cane according to aspects of the present invention; and

FIG. 12 illustrates a user using the multi-function cane as a support cane according to aspects of the present invention.

### DETAILED DESCRIPTION

Specific examples of the present invention are now described in detail with reference to the Figures, where identical reference numbers indicate elements which are functionally similar or identical. The examples can interchange between or combine the benefits provided by a mobility cane with the support and balance characteristics of a support cane.

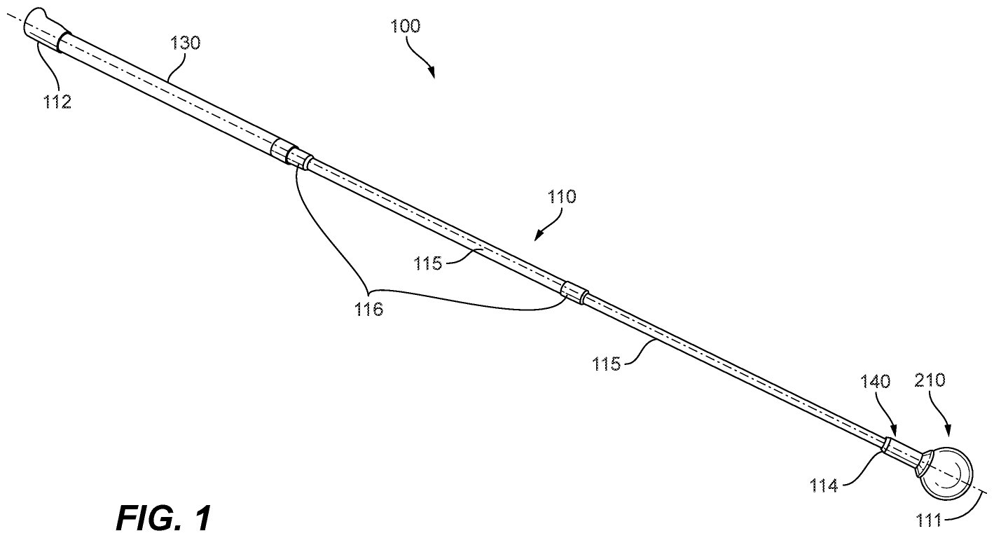

Turning to the figures, FIG. 1 illustrates a design for a multi-function cane 100. The cane 100 can have a shaft 110 which has a proximal end 112 and a distal end 114. A grip 130 can be mounted to the proximal end 112 for use in manipulating the cane, such that when held with the grip used for a typically mobility cane, the distal end 114 is at or near the walking surface. Grip 130 can be mounted using any means, materials, or combinations typically used to attach a grip to a cane, including fasteners, adhesives, cords, press fit, or some other method.

As used herein, the “ground”, “surface”, “walking surface”, “terrain”, and the like can be any surface along which the user is moving. For example, the surface can be domesticated flooring that is relatively flat, such as carpeting, wood, or linoleum, and can extend to paved surfaces such as sidewalks, driveways, and urban streets. Other surface examples can include natural, uneven surfaces such as the dirt, sand, rocks, roots, and other asperities found on typical hiking trails.

The shaft 110 can have any form typical of that used for mobility canes (white canes), support canes, or other similar mobility aids. The shaft 110 can be constructed of any materials or combination thereof suited for construction of a cane, such as wood, metals, natural or synthetic polymers, fiberglass, or resins and ceramics. Many such materials can be copolymers or contain embedded amorphous or directional reinforcement. In a preferred example, the shaft 110 can have carbon fiber and/or aluminum construction having a high strength to weight ratio. Portions of the shaft can be colored white and red as is commonly seen on commercially available mobility cane embodiments, with reflective properties afforded for safe usage in more crowded environments.

The shaft 110 can be an elongate tubular structure with a single monolithic piece or multiple pieces joined together. In some examples, the shaft can have a squared or other polygonal cross section. The shaft 110 can be designed so the overall length 113 of the multi-function cane is adjustable through movement of the plurality of parts, such that the shaft has a collapsed configuration and an expanded configuration. The shaft can be a number of tightly-fitting tubular telescoping segments 115 interfacing at joints 116. In the example shown, the shaft 110 has two telescoping segments 115 and two joints 116, but a greater or lesser number can be used for varying circumstances.

Wall thickness and other dimensional characteristics of the telescoping segments 115 can be chosen from examples in the cane art which provide a robust column stiffness for bearing some vertical weight, while being easy to maneuver. In some examples, polymeric rings or tapered sleeves can be provided near the extremities of each tube to promote sliding while maintaining a tight fit against dimensional variation and wear from repeated adjustment.

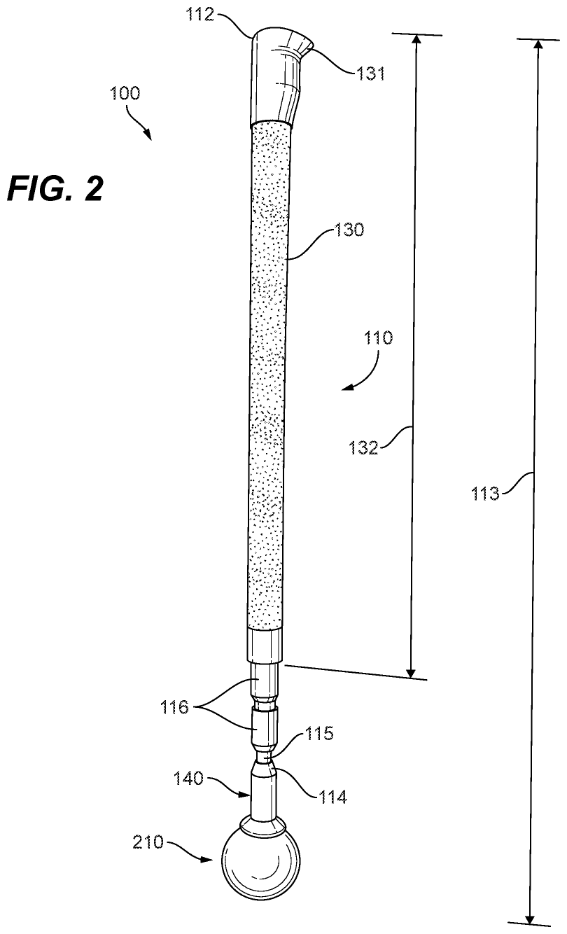

FIG. 2 illustrates a design where hollow telescoping segments 115 in tubular form are in a collapsed configuration for ease of transport and storage when not in use. Extension and retraction can be accomplished through telescoping motion of the numerous segments 115 which slide relative to each other at joints 116 along the longitudinal axis 111. Segments 115 can be joined, for example, on a cord to be folded against each other, or held together by threads or a press fit in a joined state.

The shaft 110 can be extended to give the cane a length 113 such that it reaches approximate a user's sternum when perpendicular to the ground. In other cases, the shaft can provide a length 113 so the cane 100 can be used as a walking support cane largely perpendicular to a walking surface, with the proximal end 112 reaching near abdomen of the user. Standard walking support canes are typically offered at fixed lengths of approximately 36-37 inches. In still other examples, the shaft can be extended such that the length 113 is any length suitable for use as a “white” or mobility cane, with the shaft 110 canting away from the body at a downward angle and the distal tip 210 resting on the walking surface. Mobility canes are typically offered in lengths up to approximately 58 inches.

To increase utility, it can be appreciated that a lesser or greater number of segments and joints can be combined to give the cane 100 a greater range of potential sizes combined with the ability to decrease the overall package size for portability. In some examples, the cane 100 can be configured to collapse to a length of 20 inches or less so as to be compatible with standard sized travel luggage and other packaging. In other examples, the grip 130 can be removable, by means of integral threads or other suitable method.

As further illustrated in FIG. 2, the grip 130 can have a rubberized rippled, dimpled, overmolded, or otherwise textured surface, and terminate near the proximal end 112 of the shaft 110 in a heel 131. The heel 131 can have a radially asymmetric profile with elongated contours to fit in the crotch of the hand to resist otherwise unintended rotation of the cane 100. The shape of the grip 130 can be any suitable for use with a cane. The shape can be a largely longitudinal structure as shown, but other examples can include a curved or angled handle.

The grip 130 can have an axial length 132 sized to ensure it provides a comfortable and ergonomic hand position when the cane is configured in any of the lengths mentioned above. Any suitable length 132 can be contemplated, which can be longer than that encountered on many commercially available trekking poles and walking sticks. As shown, the grip length 132 can be approximately 18 inches to accommodate typical complimentary biomechanical hand positions. A longer grip can also allow the user to quickly and effectively “choke up” or “choke down” on the grip as commonly done with baseball bats and golf clubs for situations where their gait and/or stride changes (e.g., when hiking as opposed to transiting a paved surface).

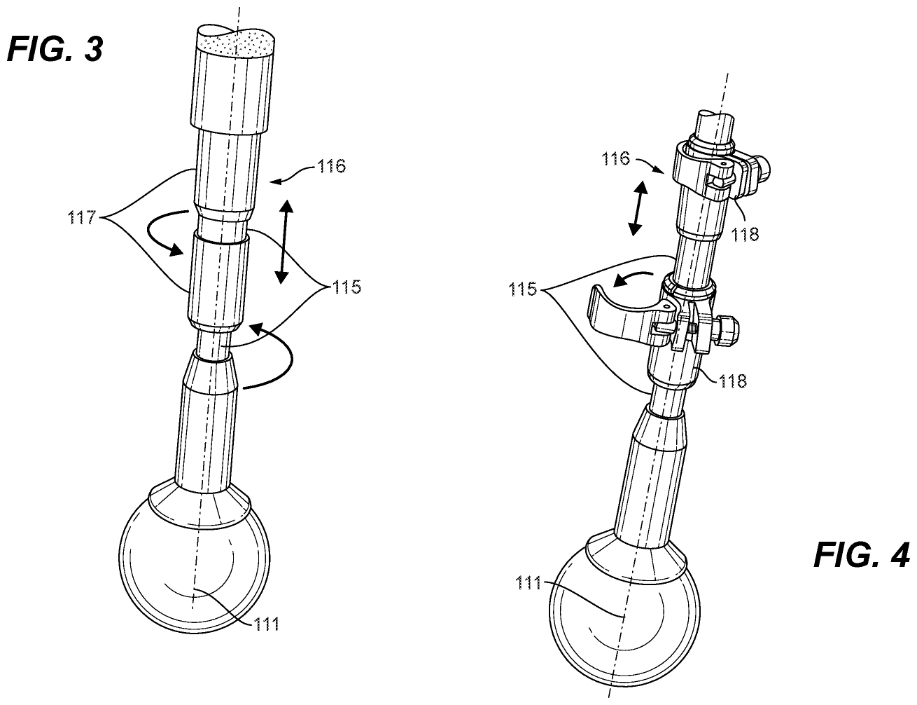

In many shaft designs, latching or locking mechanisms can be utilized at the joints 116 to rigidly maintain the positions of the telescoping segments 115 relative to each other. Several means for locking the adjusted lengths of the segments are known in the art. In FIG. 3, twist lock 117 collars are positioned along the longitudinal axis 111 which, when tightened, fix the relative exposed length of adjacent segments 115. The twisting action can be used to create a compression friction fit, or alternately to drive a screw or expand a grommet for holding in place the relative longitudinal telescoping members 115. Twist locks can offer rapid adjustment and strength without the need for much additional complexity or cost. FIG. 4 shows an alternative draw latch design with tab locks 118 at the joints 116, which can include a cam positioned at the end of a lever. The cam can offer secure latching while also providing physical and visual confirmation of locking. Other examples, such as spring-loaded snap buttons, can also be used.

In addition, the shaft 110 can also be equipped with overextension protection, such as a collar acting as a physical stop or similar implement, to prevent the telescoping segments 115 from extending beyond their designed adjustment range or axially liberating from each other. Additionally, the individual segments can have indicators at various lengths designed to inform a visually impaired individual of their relative position and degree of extension. Such indicators can offer tactile feedback, such as tactile tiles or strips utilizing patterns of various density corresponding to degree of extension.

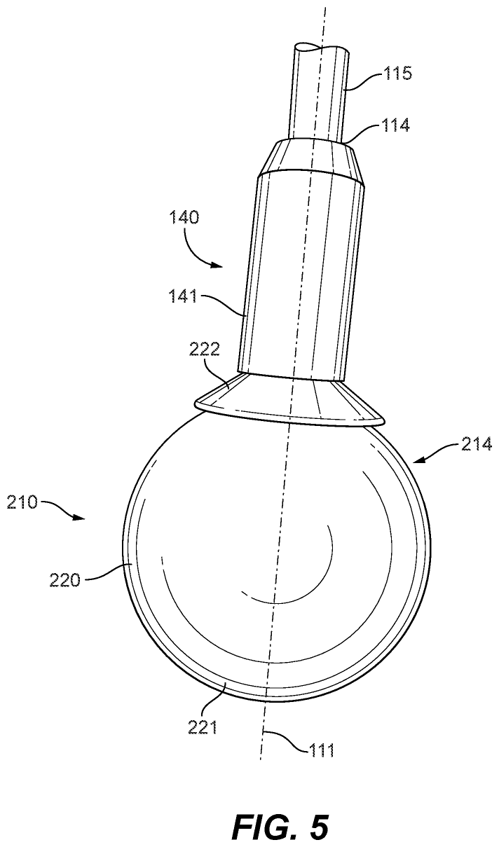

At the distal end 114 of shaft 110, the multi-function cane 100 can have a compression brake 140 and distal tip 210 as shown in FIG. 5. The distal tip 210 can have a proximal portion (not shown) and a distal portion 214. The tip 210 can be any shape suitable for low friction rolling or sliding, such as a ball, cylinder, or disk. In some examples, the distal portion 214 can be a ball 220 having a hemispherical distal free surface 221 for contact with the walking surface. The free surface 221 of the distal portion 214 can have a similar level of traction as found on mobility canes and can assume a number of shapes and profiles which provide very little resistance to facilitate the rolling or sliding functions of a mobility cane when scanning. The ball 220 can be configured to rotate about the longitudinal axis 111 of the shaft 110. The ball 220 can have a radial size similar to that seen in the mobility cane art. In one example, the ball 220 can have a diameter of approximately two inches. A larger or heavier ball can be substituted based on the preference of the user.

The ball 220 of the distal tip 210 can have low friction properties afforded by its shape and also its material. Typical polymeric materials used for mobility cane tips like nylon can be used. Other lightweight options such as aluminum or certain ceramics can also be used.

A shroud 222 can be affixed above the ball 220. The shroud 222 can be stationary and attached to housing 141 of the compression brake 140 to shield the more proximal regions of the tip 210 from snagging on objects or obstacles as the ball 220 is rotating. The shape of the shroud 222 keeps the ball 220 centered with respect to the shaft axis 111 such that both scanning motions (when the cane is used as a mobility cane) and support functions (when the cane is used as a support cane, walking stick, etc.) are balanced without extra effort from the user.

The compression brake 140 can have a housing 141 affixed to the most distal of the telescoping segments 115 at the distal end 114 of the elongate shaft 110. The compression brake 140 can be operatively coupled with the distal tip 210 in such way that it meters rotation of the ball 220 around the longitudinal axis 111. When the cane is needed for support, the user can apply a force to the cane shaft using the handle which can apply the brake to fix the tip for increased stability. A longitudinal force applied in this way engages the brake to prevent tip roll. By shortening the shaft 110 in these situations, a user can already have their arms in a position to transfer leverage to the cane similar to when using a hiking pole or walking stick. This more natural position allows a user to proportionally output more power to the cane than would be available utilizing a mobility can posture, which helps to propel them over terrain they are traversing.

A similar benefit can arise when a user is traversing a natural surface and encounters an unexpected crevice, root, rock, or other obstacle. The tip 210 can catch on the obstacle and the user's momentum engages the brake to steady the cane for balance and stability.

The tip 210 can also be configured to be removable from the shaft 110 of the cane 100. This can be beneficial for repair or replacement of the tip. Alternatively, removal can allow the substitution of a tip 210 with materials or shapes which are more beneficial for the walking surfaces a user is cognitive of (or anticipates) experiencing. The multi-function canes disclosed herein are therefore more versatile for their ability to readily accept interchangeable tips for improved traction on varying terrains.

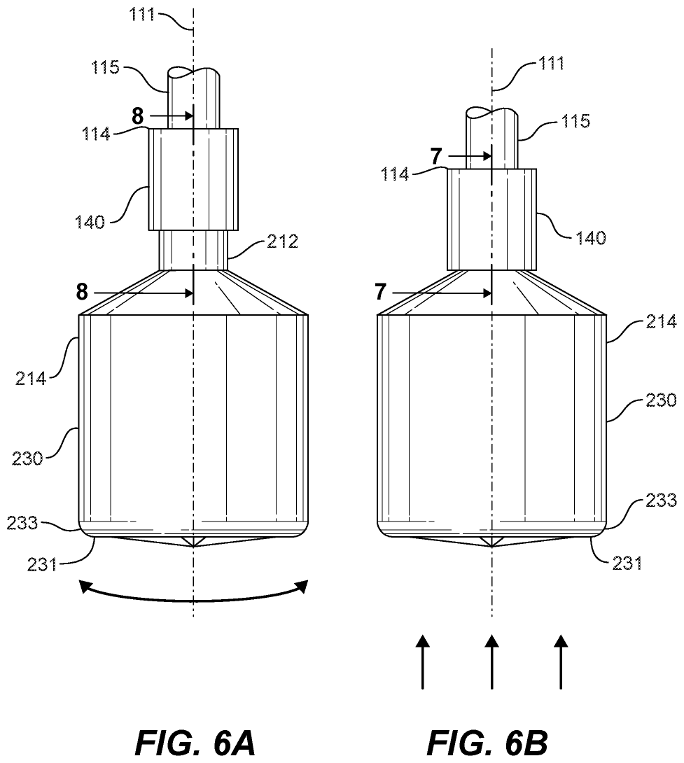

In other examples, the distal tip 210 can be of similar form to that presented in FIG. 5 but otherwise have a substantially cylindrical form 230 for the distal rotating portion 214 of the tip, as illustrated in FIG. 6A and FIG. 6B. The cylindrical tip 230 can effectively be journaled so the compression brake serves as a sleeve bearing-type assembly, allowing the tip 230 to roll on its edge along a surface similar to disclosed ball designs. The tip 230 can have a proximal cylindrical portion 212 engaged and supported within the housing 141 of the compression brake 140 so as to be rotatable around the longitudinal axis 111 with respect to the brake 140. When used as a mobility cane, the movement of a tip with this cylindrical shape is akin to that of a drum or barrel being rolled along the edge of its bottom rim.

The cylindrical tip 230 can have fillet 233 around the distal edge so that a user can readily feel and balance the distal tip on the ground. The cylindrical profile offers a tip which can have a substantially flat free surface 231 so that, when the cane is inclined above a certain angle above the walking surface, it does not easily slide forward but still allows the sideways arc scanning motion by rolling when a normal transverse force is applied.

Viewing FIGS. 6A and 6B in closer detail, the proximal cylindrical section 212 of the cylindrical tip 230 can project a distance from the housing 141 of the compression brake 140 when the brake is “open” or other otherwise not engaged. This configuration allows the tip to rotate about the axis 111 as indicated by the arrows. An actuating longitudinal, compressive force, as indicated by the arrows acting on the distal free surface 231 in FIG. 6B, can translate the cylindrical section 212 proximally into the housing 141 of the brake 140 to engage the brake and prevent tip roll when the cane is used as support.

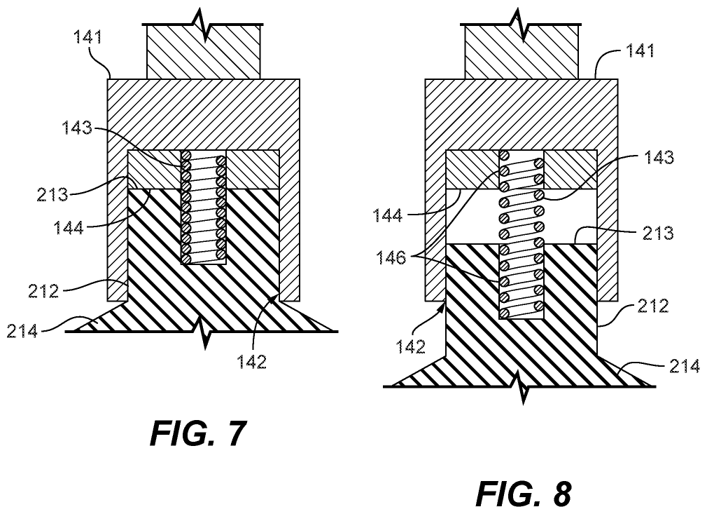

FIG. 7 shows a cross section view of a portion of FIG. 6A illustrating the relative orientations of the brake housing 141 and proximal 212 and distal 214 portions of the tip when the compression brake 140 is in the “open” or disengaged position. The housing 141 can have a recess 142 extending at least partially through the longitudinal length of the housing and sized to receive the proximal cylindrical portion 212 of the tip with a radially snug fit. A more proximal region of the recess can have a high friction surface 144 configured to engage with a proximal face 213 of the cylindrical section 212 when the brake is “closed” or engaged. Both the high friction surface 144 and the cylindrical section 212 can have cylindrical holes or indentations 146 allowing the spring 143 to seat at either end and keeping the spring centered regardless of the axial position of the tip 230. The indentations 146 can also leave the proximal section 212 of the tip free such that rotation of the tip is unhindered when the brake is not engaged.

The high friction surface 144 can be integral with the housing 141 or it can be an insert constructed from rubber, polyurethane, or similar material. In one example, the interface between the high friction surface 144 and the proximal face 213 can be substantially flat or planar as shown. In a separate example, the interface can have a radially symmetric conical shape and corresponding cavity to increase the area of the load-bearing contact surface. Other forms of the high friction surface 144 in combination with the proximal face 213 can also be contemplated which increases surface contact area. In still other examples. the proximal face 213 can also be adhered, constructed, or coated so as to also be a high friction surface.

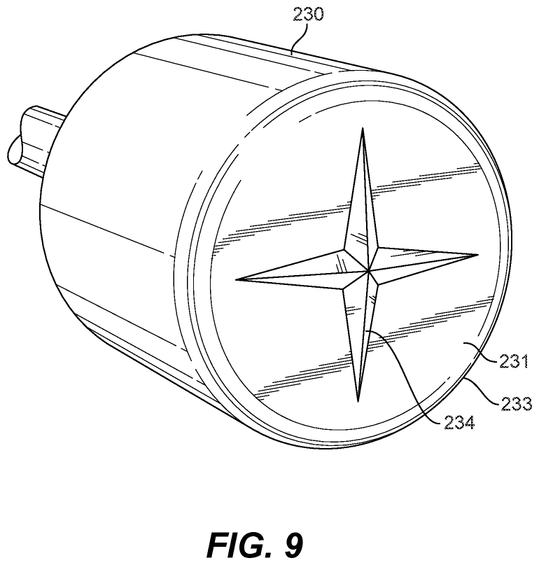

FIG. 8 is a cross section view of FIG. 6B. In this orientation, the compression brake 140 is in a “closed” or engaged configuration to inhibit rotation of the tip 230 for when the cane is desired to bear some of the user's weight. The spring 143 is compressed by the proximal motion of the tip 230 closing the relative gap between the proximal face 213 and the high friction surface 144. Features 146 in one or both of the high friction surface and proximal face can keep the spring 143 centered about the axis 111 during brake engagement until the surfaces contact. When the external longitudinal load is removed, the spring 143 can recover elastically to disengage the brake and push the distal tip to the nominal “open” location.

It should be noted that although the cross sections for this type of engagement system for the compression brake 140 are derived from FIGS. 6A and 6B, it can be utilized regardless of the geometry of the distal portion 214 of the tip. It can also provide a convenient mechanism for substitution of one type of distal tip for another.

Although the fillet 233 (as earlier referenced in FIGS. 6A and 6B) or other rolling surface of the distal tip 210 can have low coefficients of static friction to contact the surfaces typically encountered by mobility canes, at least a portion of the distal free surface 231 can be afforded higher friction or non-slip properties so as to be advantageous when the cane is used for traction in a support mode. Referring to FIG. 9, the distal free surface 231 of the cylindrical tip 230 can be made from materials or otherwise given properties so that it has a static coefficient of friction of 0.4 to 0.5 or more. When in a more vertical orientation like a support cane, the free surface 231 can more approximately be parallel to the walking surface, giving it the ability to “catch” the walking surface when traversed. A more angled orientation, like that used to deploy a mobility cane, would leave the higher friction portion exposed and unused for those functions.

In some examples, such as that illustrated in FIG. 9, at least a portion of the distal free surface 231 can have a tread plate (sometimes referred to as diamond plate or checker plate) or similar pattern embossed to extend from the surface. Tread plate can be a more durable and wear resistant means of obtaining low- or non-slip properties for the tip when used as a support or hiking cane, when the distal free surface 231 is often in-plane with the walking surface, causing the contact portion of the tip to have increased friction with the surface for weight bearing stability.

In other examples, the distal free surface 231 can get its friction properties from a coating or other object adhered to or embedded in the distal tip 210 to act in a similar fashion to a bumper. In one example, the object can be adhesive backed like a furniture bumper and fit snugly within a recess near the distal end of the tip. In another example, the tip edges can be masked and a robust plasticized coating can be applied. The friction properties can be obtained by using certain materials or combination of materials, typically elastomers such as rubber or polyurethane.

Based on conditions or personal preference, a given cane tip can be substituted for another. For example, a user may desire to switch a cylindrical tip for a ball-type tip, which can be the preferred choice for natural walking surfaces due to the ability to more easily trace around and over surface asperities, such as roots and rocks. Alternatively, a user may prefer the feedback of a larger or heavier tip when scanning surfaces.

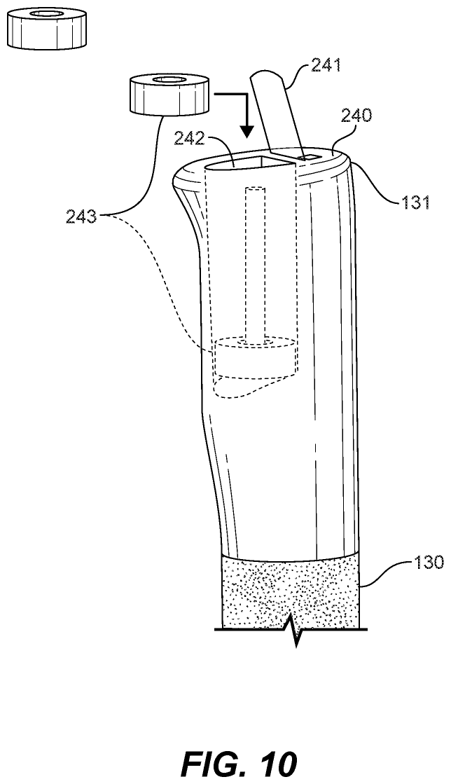

Under such circumstances, the disclosed designs can have the ability to add proximal weight to counterbalance the cane, as depicted in FIG. 10. Counterbalancing can help alleviate increased torque from the cane tip to reduce forearm fatigue and generate smoother feedback. The heel 131 of the grip 130 can have an otherwise smooth face 240 with a hinged latch 241 for accessing an internal grip chamber 242. The latch 241 can have a press fit or other similar configuration so that it seats flush with the heel face 240 in a nominally closed position. When opened, chamber 242 can be accessed for the installation of individual balancing weights 243 to compensate for changes in tip configuration, or to otherwise tune and stabilize the cane. In one instance, weights 243 can be supplied in compact 0.5 ounce discs as shown which can be secured within the chamber 242 by the latch 241. Other examples using clip on or threaded weights can also be envisioned.

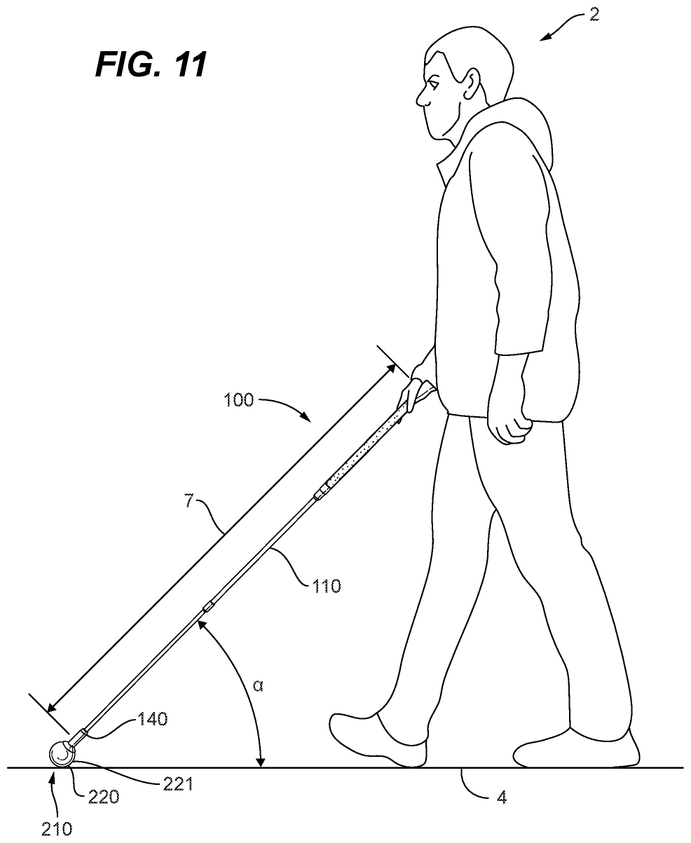

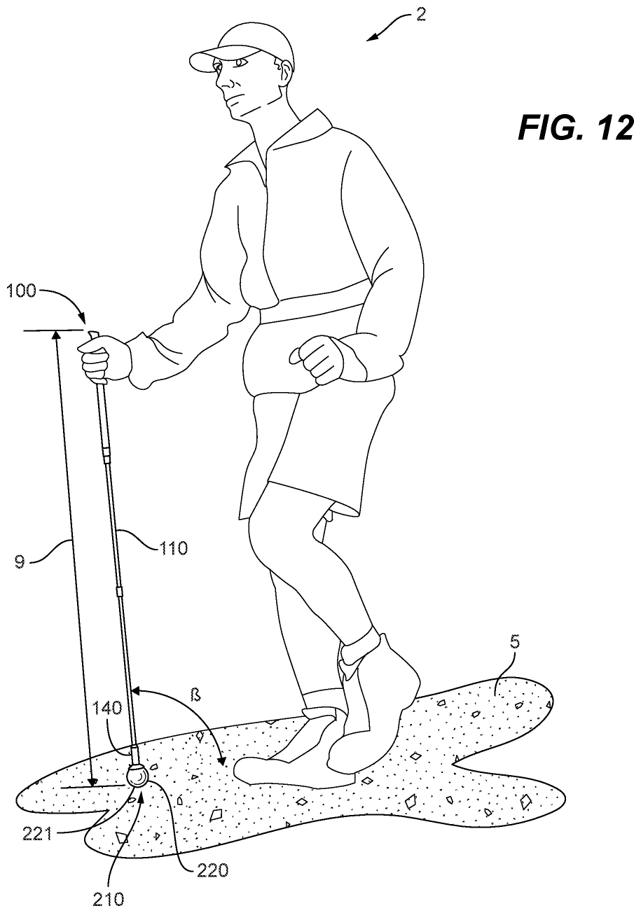

Example methods or processes for the use of a multi-function cane by a visually impaired user are illustrated pictorially in FIGS. 11 and 12. The method steps can be implemented for any of the example devices or suitable alternatives described herein and known to one of ordinary skill in the art. The method can have some or all the steps described, and in many cases, steps can be performed in a different order than that disclosed below.

FIG. 11 shows a visually impaired user 2 holding the multi-function cane 100 in a “mobility mode” as a mobility cane at an angle a with the walking surface 4. Typically, this angle can be approximately equal to or less than 60 degrees, but even shallower angles can often be used to avoid inducing axial loads or give a greater range of detection. The cane 100 can have the shaft 110 extended to a length 7 such that it is functional and comfortable for the user 2. In one example, the multi-function cane 100 cane be held in a grip extending parallel to the shaft of the cane with the palm facing up and the distal tip 210 resting on the walking surface 4. The distal tip can be in rotatably disposed with respect to a compression brake 140 and shaft 110 of the cane 100. In some examples the distal tip 210 can be a ball 220 which contacts the surface 4 on a part of its hemispherical distal surface 221, in point contact so there is minimal friction present when the cane 100 is moved.

The method can involve a user applying a reversible transverse load to the cane 100 with the compression brake “open” or disengaged so the distal tip can rotate freely. In the “mobility mode”, the cane is not used to support any component of the user's weight or other vertical/longitudinal forces. The rotating tip 210 scans or searches an arc in advance of the user's course and can detect obstacles and inform the traveler about the conditions of the path underfoot, which the user can incorporate for safety and ease of mobility.

In some examples, a step of the method can involve the user encountering uneven, unpaved, or similarly rough terrain. By way of example and not limitation, a similar alternative step can involve the user's commute encompassing transit on a bus or train, where impulses from accelerations/decelerations induce frequent imbalance. Under these circumstances, a visually impaired user would normally be required to carry a second cane for support.

However, with the disclosed designs, a further step can involve the user transitioning their grip to that commonly associated with a walking stick or trekking pole, with the multi-function cane in a more vertical posture, as shown in FIG. 12. The length 9 of the shaft 110 of the cane can be adjusted so that the support ground angle β with the walking surface 5 is closer to 90 degrees and the user 2 has more leverage over the vertical or longitudinal forces applied to the cane 100.

Vertical reaction forces with the ground 5 can put the cane in compression to provide stability and surface feedback during transit. When the user 2 needs support from the cane, or in response to movements requiring additional balance, an axial load can be placed on the cane 100 to compress a spring and engage the compression brake 140 in the “closed” position. The distal tip 210 is prevented from rotating when the compression brake 140 is in the “closed” configuration so the cane 100 is a stable platform. The distal tip 210 can have features or objects giving at least a portion of the free distal surface a higher static friction coefficient to prevent slippage when the cane is held in the “support mode” and the contact patch is near coaxial with the cane axis. The user 2 can lift the cane 100 from the surface 5 to simultaneously disengage the brake 140 and reposition the cane before reapplying the axial load in concert with the user's stride, as would be done with a support cane, walking stick, or a trekking pole. These steps as described can be used to facilitate planned activities on more complex terrain such as hiking, so the visually impaired user can carry a single cane and maintain a free hand for balance and other activities.

A user can transition freely and easily transition between the “mobility mode” of FIG. 11 and the “support mode” of FIG. 12 by adjusting the length 7, 9 and angle α, β of the multi-function cane 100 with respect to the walking surface 4, 5 and using axial pressure to actuate the compression brake 140. The cyclic compression of the spring also means the brake can serve as a shock absorber to reduce joint fatigue during these activities.

Examples provided herein thus provide an inexpensive and effective mechanism to improve standard mobility and support canes by allowing a single device to perform both functions. This ability can decrease accidents resulting from inadvertently loading a mobility cane and improve locomotion and balance in many environments where a single tool allows the user to have a free hand for other functions. The advantages for many applications, such as hiking, are readily appreciated and embraced within this scope.

The invention is not necessarily limited to the examples described, which can be varied in construction and detail. The terms “distal” and “proximal” are used throughout the preceding description and are meant to refer to a positions and directions relative to a user. As such, “distal” or distally” refer to a position distant to or a direction away from the user. Similarly, “proximal” or “proximally” refer to a position near or a direction towards the user. Furthermore, the singular forms “a,” “an,” and “the” include plural referents unless the context clearly dictates otherwise.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 99%.

In describing example embodiments, terminology has been resorted to for the sake of clarity. As a result, not all possible combinations have been listed, and such variants are often apparent to those of skill in the art and are intended to be within the scope of the claims which follow. It is intended that each term contemplates its broadest meaning as understood by those skilled in the art and includes all technical equivalents that operate in a similar manner to accomplish a similar purpose without departing from the scope and spirit of the invention. It is also to be understood that the mention of one or more steps of a method does not preclude the presence of additional method steps or intervening method steps between those steps expressly identified. Similarly, some steps of a method can be performed in a different order, or combined in a different manner, than those described herein without departing from the scope of the disclosed technology.

What is claimed is:

1. A multi-function cane for a vision-impaired user comprising:
an elongate shaft comprising a longitudinal axis, a proximal end, a distal end, a grip disposed at the proximal end, and a plurality of telescoping segments comprising a collapsed configuration and an expanded configuration;
a compression brake comprising a housing disposed at the distal end of the elongate shaft, the compression brake preventing relative motion between the distal tip and the elongate shaft of the multi-function cane when a compressive force is applied to the cane by the user; and
a distal tip disposed distal to the compression brake and comprising a distal portion with a free end for contacting a surface upon which the vision-impaired user is standing; and

2. The multi-function cane of claim 1, the multi-function cane being a mobility cane.

3. The multi-function cane of claim 1, the multi-function cane being a support cane.

4. The multi-function cane of claim 1, the distal tip comprising a substantially spherical ball.

5. The multi-function cane of claim 1, the distal tip comprising a substantially cylindrical profile.

6. The multi-function cane of claim 5, the distal tip further comprising a distal face with a tread plate pattern.

7. The multi-function cane of claim 1, the plurality of telescoping segments capable of moving telescopically with respect to one another at joints along the longitudinal axis between the collapsed configuration the expanded configuration.

8. The multi-function cane of claim 7, each of the joints comprising one of a twist lock feature or a tab lock feature capable of fixing a cane length between the collapsed configuration and the expanded deployed configuration.

9. The multi-function cane of claim 1, the housing of the compression brake comprising a recess, a spring, and at least one high-friction surface.

10. The multi-function cane of claim 9, the distal tip can further comprise a cylindrical proximal portion comprising a proximal face, the cylindrical proximal portion sized to be movable within the recess of the housing of the compression brake.

11. The multi-function cane of claim 9, the cylindrical proximal portion being free to rotate with respect to the spring and the housing of the compression brake.

12. The multi-function cane of claim 11, the spring moving the proximal face of the cylindrical proximal portion of the distal tip distally away from the high-friction surface of the housing to disengage the compression brake; and
a compressive force applied to the multi-function cane moving the proximal face of the cylindrical proximal portion of the distal tip proximally into contact with the high-friction surface of the housing to engage the compression brake.

13. The multi-function cane of claim 1, the vision-impaired user may use the cane in a mobility mode for identifying objects around the user by disengaging the compression brake.

14. The multi-function cane of claim 1, the vision-impaired user may use the cane in a supporting mode by applying a compressive force to engage the compression brake.

15. A multi-function cane for a vision-impaired user comprising:
an elongate shaft comprising a longitudinal axis, a proximal end having a grip, a distal end, and a plurality of telescoping segments comprising a collapsed configuration and an expanded configuration; and
a distal tip disposed at the distal end of the elongate shaft comprising a comprising a substantially spherical ball rotatable about the longitudinal axis and a compression brake disposed between the distal end of the elongate shaft and the distal tip;
the compression brake comprising an engaged configuration and an open configuration.

16. The multi-function cane of claim 15, the engaged configuration of the compression brake preventing relative motion between the distal tip and the elongate shaft when a compressive force is applied to the cane by the vision-impaired user for support.

17. The multi-function cane of claim 15, the open configuration of the compression brake allowing relative motion between the distal tip and the elongate shaft for mobility of the vision-impaired user.

18. The multi-function cane of claim 15, the plurality of telescoping segments capable of moving telescopically with respect to one another at joints along the longitudinal axis.

19. The multi-function cane of claim 18, each of the joints comprising a locking feature capable of fixing the position of adjacent telescoping segments.

20. The multi-function cane of claim 15, the grip comprising an axial length of approximately 18 inches.
